(19) United States
(12) Patent Application Publication
(10) Pub. No.: US 2011/0007415 A1
(43) Pub. Date: Jan. 13, 2011

(54) METHOD AND APPARATUS FOR DETECTING SYNC DATA OF READ DATA IN A DISK DRIVE

(75) Inventors: Aya Tanaka, Ome-shi (JP); Masahiko Tsunoda, Hachioji-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/732,044

(22) Filed: Mar. 25, 2010

(30) Foreign Application Priority Data
Jul. 9, 2009 (JP) 2009-162931

(51) Int. Cl. G11B 5/09

(52) U.S. Cl. 360/48; G9B/5.033

(57) ABSTRACT

According to one embodiment, a disk drive is provided, which starts reading data at the head thereof, when a sync mark is detected. The disk drive has a read channel that generates a forced SM detection signal if the sync mark cannot be detected because of the occurrence of TA. The read channel starts generating the forced SM detection signal at the end position of a preamble, which is equivalent to the position of the sync mark.

### CROSS-REFERENCE TO RELATED APPLICATIONS

This application is based upon and claims the benefit of priority from Japanese Patent Application No. 2009-162931, filed Jul. 9, 2009, the entire contents of which are incorporated herein by reference.

### BACKGROUND

1. Field

One embodiment of the present invention relates generally to a disk drive, and more particularly to a technique of detecting the start of data in the process of reading the data.

2. Description of the Related Art

Most disk drive, a representative example of which is a hard disk drive, incorporate a signal processing circuit called a read channel that performs a read process of reproducing data (user data) recorded on a disk used as a recording medium. The read channel detects the sync mark (hereinafter abbreviated “SM” in some cases) contained in the data read from by a head. The SM is data recorded on the disk and represents the head of the data recorded on the disk. It is also referred to as a sync byte (SB).

The read channel performs a signal processing, in which a read signal is read at the timing of the SM detection signal and the data is reproduced, first at the head. The read channel transmits the read data, thus reproduced, to the disk controller. The format of the recorded data has an area called the preamble (or PLL area) immediately before the SM. In the preamble, a sync signal is recorded, which is used to generate a read-reference clock signal that will be used in the process of reproducing data.

The SM may not be detected from a read signal because of, for example, the thermal asperity (TA) occurred in the preamble or the SM area. If the SM cannot be detected, the process of reading data (data reproduction process) can no longer be performed.

In order to solve this problem, a prior-art method has been proposed. In this technique, an TA detector should detects the position where the TA has generated if the SM is not detected because of the TA, and a forced SM detection signal is generated at the timing synchronous with the recorded data (NRZ data) after a counter has counted a preset value, starting at the position detected. (See, for example, Jpn. Pat. Appln. KOKAI Publication No. 2000-123308.) In this prior-art method, an SM signal is forcedly generated, rendering it possible to read the data.

In the disk drive, the read channel inputs the read signal that has been read from the heat at the read-gate (RG) timing. The read-gate timing varies influenced by the rotational fluctuation of the disk. Thus, the read-gate timing inevitably changes every time data is read. In the prior-art method, the SM detection signal forcedly generated is synchronous with the recorded data (NRZ data). Consequently, the change in the read-gate timing may, in all probability, result in a timing lag between the forced generation of the SM detection signal and the detection of the SM. The success probability of data reading will therefore decrease if the read-gate timing greatly varies.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the major components of a disk drive according to an embodiment of this invention;

FIGS. 2A, 2B, 2C, 2D, 2E, 2F, 2G and 2H are timing charts explaining a data detection process according to the embodiment;

FIG. 3 is a flowchart explaining the data detection process according to the embodiment;

FIG. 4 is a block diagram showing the major components of a disk drive according to an another embodiment of this invention; and

FIGS. 5A, 5B, 5C, 5D, 5E, 5F, 5G and 5H are timing charts explaining the data detection process according to the embodiment.

### DETAILED DESCRIPTION

Various embodiments according to the invention will be described hereinafter with reference to the accompanying drawings.

One embodiment provide a disk drive that generate an SM detection signal of high precision if no SM detection signals have not detected, thereby archiving reliable data reading in spite of changes in the timing position of the read gate.

### [Configuration of the Disk Drive]

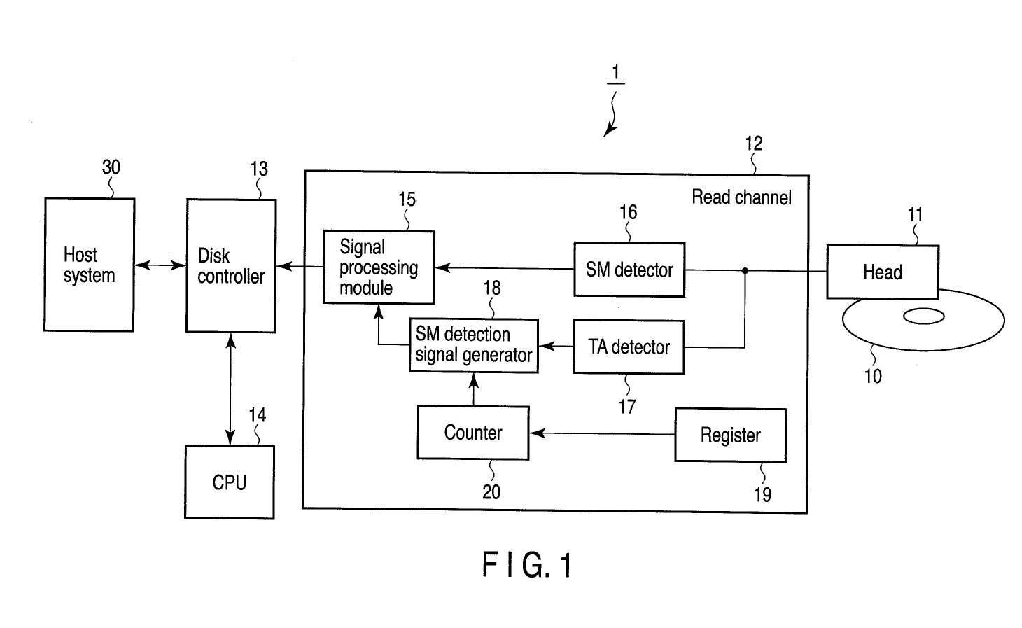

FIG. 1 is a block diagram showing the configuration of a disk drive 1 according to an embodiment.

As shown in FIG. 1, the disk drive 1 has a disk 10, a head 11, a read channel 12, a disk controller 13, and a microprocessor (CUP) 14. The disk 10 is rotated by a spindle motor. The head 11 is mounted on an actuator.

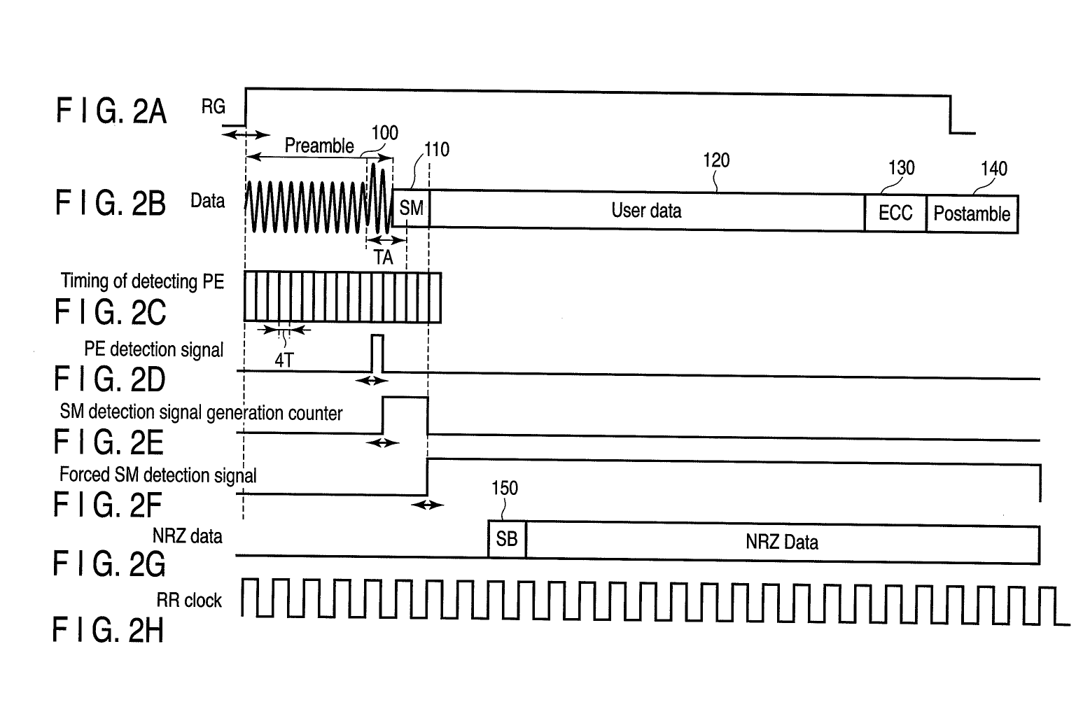

The head 11 writes data on the disk 10, whereby a number of tracks (cylinders) are formed on the disk 10. Each track is composed of a plurality of sectors that have such a data format as shown in FIG. 2B. In each sector, a preamble 100, a sync mark (SM) 110, a user data 120, an error correcting code (ECC) 130, and a postamble 140 are recorded.

As controlled by the actuator, the head 11 moves over the disk 10 and is positioned at a target position. Then, the head 11 performs a data write operation and a data read operation. That is, its write head element writes data on the disk 10, and its read head element reads data from the disk 10. As will be described later, the read channel 12 processes the read signal read by the head 11, thereby reproducing the data recorded on the disk 10.

The read channel 12 of the present embodiment will be described in detail. As in most cases, the read channel 12 is integrated in a one-chip integrated circuit, together with the write channel that processes write data.

The disk controller 13 constitutes an interface between the hard disk drive 1 and a host system 30, and controls the transfer of data and commands. The disk controller 13 transfers the reproduced data output from the read channel 12 to the host system 30. Further, the disk controller 13 generates a read gate (RG) that represents the timing of a read operation (data reproducing operation) performed in the read channel 12.

The CPU 14 is the main controller of the drive 1. The CPU 14 reads a command transferred from the host system 30 via the disk controller 13 and performs the data read operation according to the present embodiment. The CPU 14 further controls the actuator, performing the positioning of the head 11 (i.e., servo control).

[Configuration of Read channel 12 and the Data Read Operation]

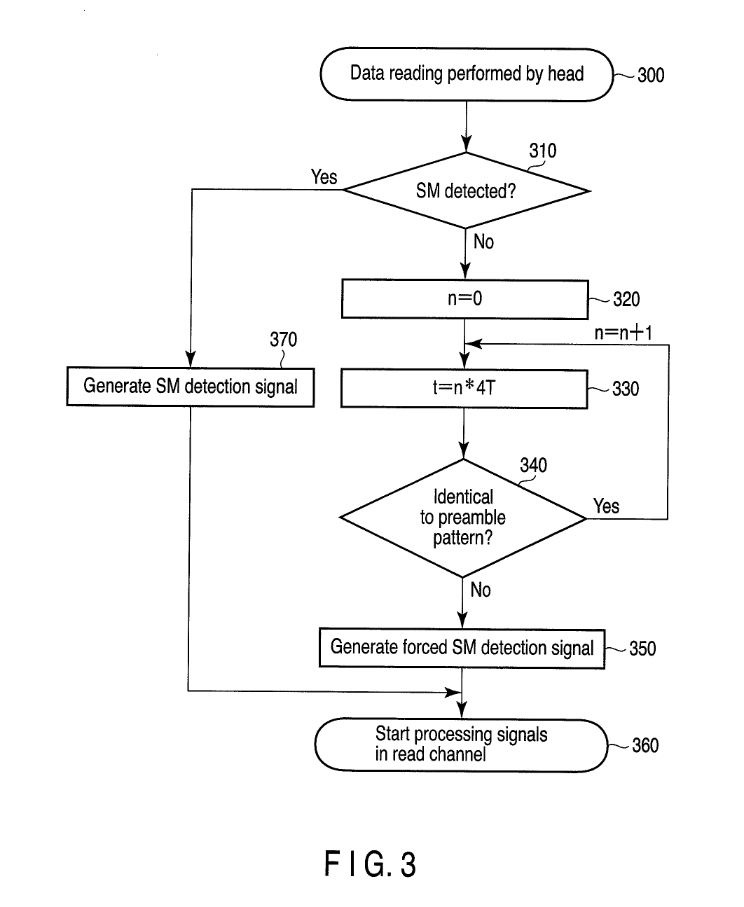

The configuration of the read channel 12 and the data read operation, both according to the present embodiment, will be described with reference to FIG. 1, FIGS. 2A to 2H and FIG. 3.

As shown in FIG. 1, the read channel 12 includes a signal processing module 15, an SM detector 16, a TA detector 17, an SM detection signal generator 18, a register 19, and a counter 20. The signal processing module 15 processes a read signal read from the head 11, reproducing the data recorded on the disk 10. More precisely, the signal-processing module 15 reads a read signal and reproduces the data from the start, in accordance with an SM detection signal which has been generated by the SM detector 16 or an SM detection signal forcibly generated by the SM detection signal generator 18 (i.e., forced SM detection signal).

As shown in FIG. 2B, the SM detector 16 outputs the SM detection signal when a sync mark (SM) 110 recorded at the start of user data 120, is detected from the read signal that the head 11 has read. From the basis of the waveform of the read signal, the TA detector 17 detects the position where thermal asperity (TA) has occurred. The TA detector 17 monitors the pattern of a preamble 100, starting at the leading edge of the read gate (RAG), detecting the end of the cyclic waveform of the pattern. From the position where the TA has been generated and the end position of the cyclic waveform of the pattern, the TA detector 17 detects the end position (PE) of the preamble 100, generating a PE detection signal.

In accordance with the PE detection signal output from the TA detector 17, the SM detection signal generator 18 generates a forced SM detection signal at the timing of measuring the time elapsed from the time the TA was generated (at the end position [PE] of the preamble 100) to the time the SM 110 was detected. The counter 20 starts the count operation at the PE used as starting point, and outputs a count-completion signal upon counting the count set in the register 19 (i.e., the time measured).

Note that the CPU 14 controls the TA detector 17, the SM detection signal generator 18, the register 19, and the counter 20.

### [Method of Reading Data]

As the shown in FIG. 2A and FIG. 3, the read channel 12 starts reading data at the timing of the read gate (RG) coming from the disk controller 13 (Block 300). Note that the read gate (RG) changes because of the rotational fluctuation of the disk 10, as is indicated by the arrow shown in FIG. 2A. At the timing of the read gate (RG), the read channel 12 causes the head 11 to input the read signal read from the disk 10, and starts reproducing the user data 120.

In normal operation, the SM detector 16 detects such a sync mark (SM) 110 as shown FIG. 2B, from the signal the head 11 has read, and outputs an SM detection signal (Block 370, YES in Block 310). In accordance with the SM detection signal output from the SM detector 16, the signal-processing module 15 reads the read signal and reproduces the data from the start of user data 120 (Block 360). The read channel 12 outputs the user data 120 reproduced by the signal-processing module 15, to the disk controller 13.

Assume that the SM detector 16 cannot detect the SM 110 (that is, NO in Block 310). In this case, no SM detection signals are output, and the signal-processing module 15 of the read channel 12 cannot perform signal processing in order to read the data.

This embodiment is designed on the assumption that the SM 110 may not be detected because of the TA generated in the preamble 100 or in the SM 110 as illustrated in FIG. 2B. In the preamble 100, a sync signal is recorded, which is long enough for acquisition operation of the PLL circuit provided in the read channel 12. That is, as shown in FIG. 2H, a reference clock (RR clock) for data reading is generated from the sync signal recorded in the preamble 100.

Suppose TA is generated at the start or intermediate part of the preamble 100. In this case, the PLL circuit malfunctions. Consequently, the read channel 12 cannot read data at all, no matter whether the SM 110 has been detected or not.

If the SM 110 is not detected (No in Block 310), the TA detector 17 starts operating at the next rotation of the disk 10, in accordance with a control signal coming from the CPU 14. As shown in FIG. 2C, the TA detector 17 starts monitoring the pattern of the preamble 100 defined by a 4 T-cyclic waveform, at the leading edge of the read gate RG. The TA detector 17 detects the end (last part) of the pattern of the preamble 100, i.e., the position where the TA has been generated. Upon detecting the TA, the TA detector 17 outputs a PE (end position) detection signal as shown in FIG. 2D.

More specifically, the TA detector 17 sets a variable n (having the initial value of 0). In each 4 T-cycle period, the TA detector 17 compares the pattern of the read signal with a reference preamble pattern, thereby determining whether the patterns are identical or not (Blocks 320, 330, 340). If the pattern of the read signal is not identical to the reference preamble pattern (NO in Block 340), the TA detector 17 detects the end of the cyclic waveform of preamble pattern, outputting a PE signal to the SM detection signal generator 18.

At the time the PE detection signal is output, the SM detection signal generator 18 measures the time terminating at the SM 110 as illustrated in FIGS. 2D to 2F, and generates a forced SM detection signal (Block 350). More precisely, as shown in FIGS. 2E and 2F, the SM detection signal generator 18 generates the forced SM detection signal in accordance with the count-completion signal coming from the counter 20. The counter 20 outputs the count-completion signal to the SM detection signal generator 18 when it counts the count set in the register 19. The count is equivalent to the time elapsing from the end of the cyclic waveform of the preamble pattern to the position of the SM 110.

On receiving the forced SM signal from the SM detection signal generator 18, the signal-processing module 15 reads the read signal as shown in FIG. 2F. Then, the signal-processing module 15 starts processing the user data 120, at the start thereof (Block 360). That is, the signal-processing module 15 reproduces, for example, NRZ data as user data 120 that contains a sync byte (SB) 150 at the head as shown in FIG. 2G. The user data (i.e., NRZ data) 120, thus reproduced in the signal-processing module 15, is sent to the disk controller 13.

In the read channel 12 configured as described above, the SM detection signal generator 18 generates a forced SM detection signal 110 if no SM 110 cannot be detected during the first rotation of the disk 10 because TA has occurred. This enables the signal-processing module 15 to process signals. Hence, the read channel 12 can perform a read process, reading the user data 120 recorded on the disk 10.

In this embodiment, the timing of generating a forced SM detection signal is determined, by assuming that TA is generated at the end of the pattern (i.e., 4 T-cyclic waveform) of the preamble 100. That is, the pattern of the preamble 100 is monitored, and the end of the pattern is regarded as the position where the counting should be started to generate the forced SM detection signal. Since the end of the preamble 100 is identical to the position of the SM 110, a forced SM detection signal of high precision can be generated, even if the read gate RG changes because of the rotational fluctuation of the disk 10. To be more specific, the timing difference between the forced SM detection signal and the actual SM detection signal is limited to “4 T−1 T,” irrespective of the leading edge of the read gate RG that is influenced by the rotational fluctuation of the disk 10.

### [Other Embodiment]

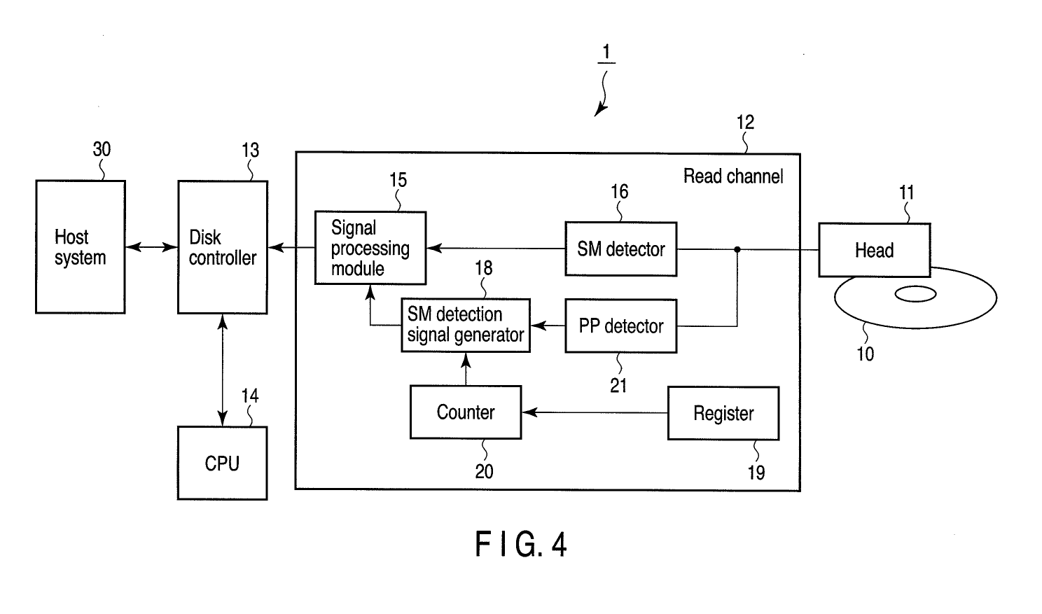

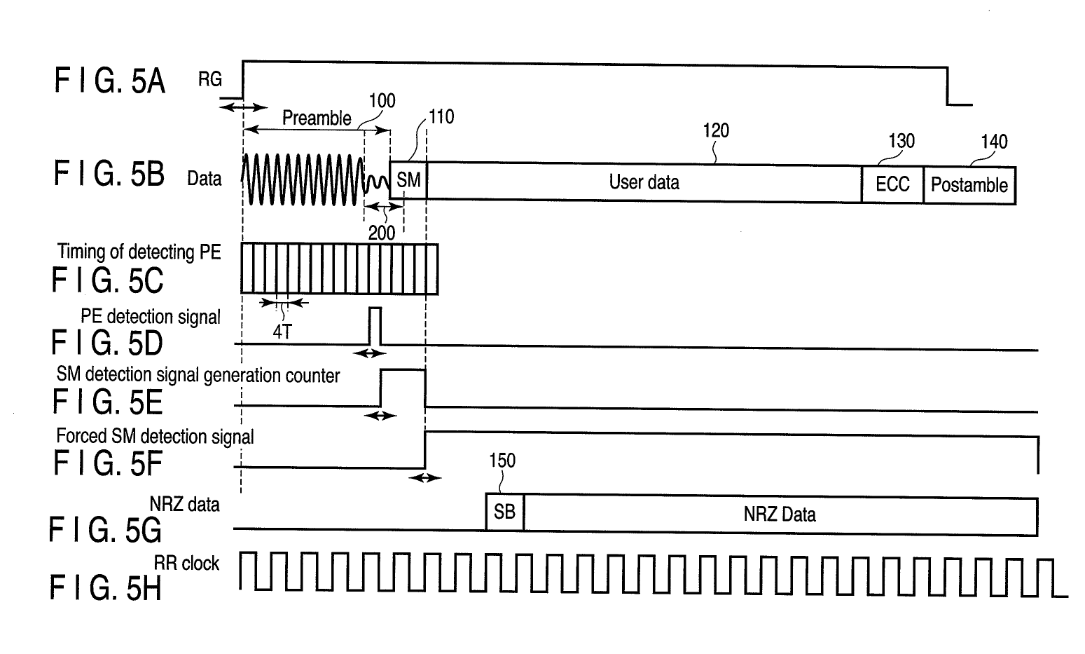

FIG. 4 and FIGS. 5A to 5H are diagrams showing the configuration of the read channel 12 of another embodiment of this invention and explaining the data read process performed by the read channel 12. The components and the timing, which are similar to those the embodiment of FIGS. 2A to 2H, will not be described in detail.

This embodiment is a method of reading data, which is used if no SM can be detected not because of TA, but because of a missing-signal defect 200 of preamble 100. The missing-signal defect 200 is a missing part of the signal, for which no sync signal is acquired in the pattern of the preamble 100 as is illustrated in FIG. 5B.

As shown in FIG. 4, the read channel 12 of this embodiment has a detector (hereinafter called a PP detector 21) configured to detect any missing part of the preamble 100, and operates under the control of the CPU 14. The data read process of this embodiment will be explained with reference to the timing charts of FIG. 5A to 5H.

First, the read channel 12 starts reading data at the timing of the read gate (RG) coming from the disk controller 13, as the shown in FIG. 5A. The SM detector 16 detects an SM 110 as shown FIG. 2B. In accordance with the SM detection signal output from the SM detector 16, the signal-processing module 15 reads the read signal and processes the same, at first that part of the read signal which represents the start of user data 120. The read channel 12 sends the user data 120 reproduced by the signal-processing module 15, to the disk controller 13.

Assume that the SM detector 16 cannot detect the SM 110 during the first rotation of the disk 10 as shown in FIG. 5B, because of a missing-signal defect of the preamble 100. In the preamble 100, a sync signal is recorded, which is long enough for acquisition operation of the PLL circuit. The sync signal is used to generate such a reference clock (RR clock) as shown in FIG. 5H.

If the SM 110 is not detected, the PP detector 21 starts operating at the next rotation of the disk 10, in accordance with a control signal coming from the CPU 14. As shown in FIG. 5C, the PP detector 21 starts monitoring the pattern of the preamble 100 defined by a 4 T-cyclic waveform, at the leading edge of the read gate RG. The PP detector 21 detects the end (last part) of the pattern of the preamble 100, i.e., the position where the missing-signal defect has occurred. Upon detecting the missing-signal defect, the PP detector 21 outputs a PE (end position) detection signal as shown in FIG. 5D.

More precisely, in each 4 T-cycle period, the PP detector 21 compares the pattern of the read signal with a reference preamble pattern, thereby determining whether the patterns are identical or not. If the pattern of the read signal is not identical to the reference preamble pattern, the PP detector 21 detects the end of the cyclic waveform of preamble pattern, outputting a PE signal to the SM detection signal generator 18.

At the time the PE detection signal is output, the SM detection signal generator 18 measures the time terminating at the SM 110 as illustrated in FIGS. 5D to 5F, and generates a forced SM detection signal. More precisely, the SM detection signal generator 18 generates the forced SM detection signal in accordance with the count-completion signal coming from the counter 20.

On receiving the forced SM signal from the SM detection signal generator 18, the signal-processing module 15 reads the read signal as shown in FIG. 5F. Then, the signal-processing module 15 starts processing the user data 120, at the start thereof. That is, the signal-processing module 15 reproduces, for example, NRZ data as user data 120 that contains a sync byte (SB) 150 at the start as shown in FIG. 5G. The user data (i.e., NRZ data) 120, thus reproduced in the signal-processing module 15, is sent to the disk controller 13.

As has been described, in read channel 12 of this embodiment, the SM detection signal generator 18 can generates a forced SM detection signal, causing the signal-processing module 15 to process the signal, even if the SM 110 cannot be detected because of the missing-signal defect of the preamble 100. Therefore, the user data 120 recorded on the disk 10 can be reproduced as the read channel 12 performs the data read process.

The SM may not be detected because of the occurrence of a missing-signal defect. In this case, the pattern of the preamble 100 is monitored, detecting the end position of the preamble. The end position Used as the position at which to start the counting for generating a forced SM detection signal. Since the end of the preamble 100 is synchronous with the SM 110, a forced SM detection signal of high precision can be generated, even if the read gate RG changes because of the rotational fluctuation of the disk 10.

The data-reading method according to this embodiment can be utilized if the SM 110 cannot be detected because of the missing-signal defect of not only the preamble 100, but also of the SM 110. If a missing-signal defect occurs at the start or middle part of the preamble 100, the PLL circuit malfunctions. In this case, the read channel 12 cannot read data, no matter whether the SM 110 has been detected or not.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A disk drive comprising:
a detector configured to detect an end position of a preamble in data stored on a disk, in a read signal from a head;
and a generator configured to generate a sync-mark detection signal for detecting a sync mark in the data, based on a period of time from the end position of the preamble to the sync mark in the data.

2. The disk driver of claim 1, wherein the detector is configured to detect the pattern of the preamble in the read signal when the sync mark is not detected, and to detect the end position from the pattern of the preamble.

3. The disk driver of claim 1, wherein the detector comprises a thermal asperity (TA) detector configured to detect the pattern of the preamble and a position where thermal asperity has occurred in the read signal when the sync mark is not detected, and the detector is configured to detect the end position from the position where the thermal asperity has occurred.

4. The disk driver of claim 1, wherein the detector comprises a pattern detector configured to detect the pattern of the preamble and a position where a missing-signal defect has occurred in the read signal when the sync mark is not detected, and the detector is configured to detect the end position from the position where the missing-signal defect has occurred.

5. The disk driver of claim 1, wherein the generator comprises a counter configured to start counting at the end position, to detect the position of the sync mark from a count from the counter, and to output the sync-mark detection signal when the position of the sync mark is detected.

6. The disk driver of claim 1, wherein the generator is configured to detect the end position during the next rotation of the disk when the sync mark is not detected in the read signal during one rotation of the disk.

7. The disk driver of claim 1, further comprising a read channel configured to read data on the disk, in accordance with the read signal from the head, wherein the read channel comprises the detector and the generator and configured to start reading the data at a start position of the data in the read signal in accordance with the sync-mark detection signal generated by the generator.

8. The disk driver of claim 7, wherein the read channel comprises:
a TA detector configured to detect the pattern of the preamble and a position where a thermal asperity has occurred in the read signal when the sync mark is not detected, and to output a detection signal representing the end position of the preamble, in accordance with the position where the thermal asperity has occurred; and
a sync mark generator configured to generate the sync-mark detection signal from the detection signal.

9. The disk driver of claim 7, wherein the read channel comprises:
a preamble pattern detector configured to detect the pattern of the preamble and a position where a missing-signal defect has occurred in the read signal when the sync mark is not detected, and to output a detection signal representing the end position of the preamble, in accordance with the position where the missing-signal defect has occurred; and
a sync mark generator configured to generate the sync-mark detection signal in the detection signal.

10. A method of detecting a start position of data in a disk drive, in order to read data on a disk in accordance with a read signal from a head, the method comprising:
detecting an end position of a preamble in the data on the disk in the read signal; and
generating a sync-mark detection signal for detecting a sync mark in the data, based on a period of time from the end position of the preamble to the sync mark in the data.
